(19) United States
(12) Patent Application Publication
(10) Pub. No.: US 2002/0143958 A1
(43) Pub. Date: Oct. 3, 2002

(54) Method and apparatus for asynchronous time-based updates of http sessions

(76) Inventors: Gabriel G. Montero, Chapel Hill, NC (US); Srinivas Hasti, Durham, NC (US); David B. Colasurdo, Raleigh, NC (US)

Correspondence Address: Theodore Naccarella, Synnestvedt & Lechner LLP, 2600 Aramark Tower, 1101 Market Street, Philadelphia, PA, 19107-2950, US

(21) Appl. No.: 09/823,120

(22) Filed: Mar. 30, 2001

(51) Int. Cl. G06F 15/16

(52) U.S. Cl. 709/228; 709/217

(57) ABSTRACT

The invention and apparatus for updating a back-end database for storing http session for access by multiple servers in a server farm in which the number of writes by the servers to the database are minimized. Particularly, each server maintains up to date copy of the http session data for each http session and writes the http session data to the back-end http session database that is accessible by all of the associated servers only at predetermined intervals. The intervals may be dictated on a purely time basis. Alternately, the interval may be after a specified number of requests are received in a given session or a specified number of changes are made to the http session data of the particular session.

### FIELD OF THE INVENTION

The invention pertains to hypertext transfer protocol (http) and the World Wide Web. More particularly, the invention pertains to maintenance of session data at the server side.

### BACKGROUND OF THE INVENTION

By now, almost everyone is familiar with the Internet and the World Wide Web (the Web). The Internet is a collection of interconnected communication networks that span the globe. Information content on the Internet is presented via pages, each page comprising a file that is stored on (or dynamically built by) a computer server that is coupled to the Internet and assigned a Uniform Resource Locator (URL), which is essentially an address on the Internet.

Web browsers are computer programs that enable one to access and view Web pages via direct addressing (typing the address of a Web page in an address field of the browser) and/or by hyperlinking, as is well known in the art. Netscape Navigator and Microsoft Explorer are two of the most common Web browsers in use today.

Hypertext transfer protocol (http) is the protocol used for transferring Web pages over the Internet. Servers are computers that form part of the Web and whose general purpose is to provide (or serve) information to other computers coupled to the Web. Those computers that are used to request and receive information via the Web from http servers are typically termed client machines or client computers.

On the Web, information is served in the form of Web pages written in HTML (HyperText Markup Language). Thus, for example, a retail Web site operator couples to the Internet via one or more http servers on which are stored a plurality of Web pages written in HTML programming language. In actuality, many Web pages are not actually stored in Web page format, but are dynamically constructed upon receipt of a request for the page.

The HTML code defines the manner of presentation of information on the client machine. The HTML code also typically includes the textual content of the page. Other types of content, such as images, audio, background, and multimedia are contained in separate, supplemental, files stored in the server which are referenced within the HTML code by HTML tags.

In a common example, a customer accesses a Web retailer's Web site from a desktop computer using a Web browser. The customer's desktop computer utilizing the Web browser software would be considered a client machine.

The Web browser requests a particular Web page using http in a manner well known to those of skill in the art. Upon receipt of the request for a particular Web page, the server system corresponding to the URL of the requested page serves the HTML code for that page to the client machine via the Internet.

Http is a connectionless transfer protocol. This means that each request for a Web page transmitted from a client to a server is completely freestanding and contains no information that relates that request to any other request. Thus, http itself has no provision for state information that would allow a server (or a client) to maintain historical information about a series of related http requests (e.g., consecutive requests for pages from a single Web site by a single client).

In many types of communication sessions between a particular client and a particular Web site, it may be desirable to associate http requests from a single client and maintain state information. For instance, at retail Web sites which, commonly use dynamically generated shopping cart pages to keep track of items being purchased by a particular client, maintaining state information is a necessity in order to keep track of the various products being added to the shopping cart by the user contained in different http requests. Countless other examples also exist. The term session will be used in this specification to refer to any group of requests for data from a network server system that one may wish to associate with each other. Typically, however, a session would comprises requests from a single client machine to a single server system that are within a certain time period of each other. The concept of sessions is not limited to use on the Internet and http, but can be applied to any communication network using any protocol.

Accordingly, ways have been developed outside of the http protocol itself for maintaining such state (or session) information. One of the earliest ways developed for doing this was the use of cookies. Cookies are small pieces of data that a server sends to a client machine and that the client's Web browser knows to store in a designated cookie folder or in the browser memory. Thereafter, when that client sends a http request for a Web page to that server, the client's Web browser software sends the cookies associated with that URL to the server. The cookie might contain any particular information that the Web site operator feels the need to have in order to better service its customers. As an example, many Web sites allow individual clients to customize Web pages, such as a daily, electronic, newspaper containing only those articles that meet certain criteria selected by the customer and which criteria are stored as part of a cookie. Cookies are a common way to allow the Web site operator to identify the particular client making a request so that they can then pull up the appropriate information associated with that client and deliver the customized Web page. Persons of skill in these arts will recognize that other mechanisms for storing state data and the like are known and used in the field. However, the use of cookies is probably the most ubiquitous of the various mechanism in use today.

The Javax.servlet.http.HTTPSession object in the Java programming language (commonly called HttpSession) is a newer way of maintaining state information at the server side. The Javax.servlet.http.HTTPSession object builds on cookies as well as some of the other means of tracking state data and the like in a layer on top of the http layer. Http session is a portion of a Java servlet API (Application Program Interface). Java is a programming language developed by Sun Microsystems, Inc. expressly for use in the distributed environment of the Internet. It can be used to create complete applications that may run on a single computer or be distributed among servers and clients in a network. It can be used to build small application modules, known as applets, for use as part of a Web page. Applets make it possible for a Web page user to interact with a page. Applets are small programs that can be delivered to a Web browser as part of an HTML page. Web browsers that include a Java Virtual Machine (JVM) can run Java applets. A JVM is the operating system process within which Java code executes. The applet can execute at the client side to provide dynamic content and/or allow for interactivity. For example, a Java applet can allow a user at a client machine enter data onto a form. Applets thus allow for dynamic Web pages and interaction between the user at the client machine and the downloaded Web page. Java and Java applets are platform independent.

An API is a specific method prescribed by a computer operating system or by another application program by which a programmer writing an application program can make requests of the operating system or other application.

A Java servlet essentially is a server-side equivalent of an applet. A Java servlet API provides Web developers with a simple, consistent, mechanism for extending the functionality of an http server and for accessing existing business systems, i.e., the application program with which the HTML code interfaces. Servlets are server and platform independent. HttpSession essentially is an object of a Java servlet API that accumulates state data. It is built using cookies (and/or other existing state data tracking techniques) and associates http requests with those cookies (and/or the particular data pieces used in other data tracking techniques).

For further information concerning HttpSession, Java servlet APIs and the other matters discussed above, reference can be made to the servlet 2.2 (or later) specification.

It is common for high traffic Web sites to divide the tasks of servicing requests in to a three tier system with a different server or plurality of servers to handle each tier.

The first, front end tier is the http server that processes the http aspects of a transaction. The second tier is termed the application server. The application server handles the content specific processing for the transactions. For instance, in a retail Web site, the application server would process the actual data for a purchase, such as creating an invoice, creating a bill of lading, checking inventory to determine if the ordered item is in stock, checking the customer's credit card information and confirming sufficient funds, record keeping, etc. The third tier comprises database servers that store the data needed to process requests. Such databases may include, for instance, a database of inventory and a database storing the content that is used to dynamically build Web pages. Within each tier, a large volume Web site server system may have multiple, redundant, servers. Particularly, any given server can only service so many requests in a given period. If the Web site expects more traffic than a single server can handle, it simply maintains multiple servers which can serve the same content. In such situations, since http is a connectionless protocol, one request from a particular client can be directed to one application server while the next request from the same client machine might be directed to a different application server. Accordingly, a means must be provided for the various servers to access the session data developed by another, redundant server.

A common way of enabling such sharing of http session data is by use of a database server that is accessible to the plurality of application servers for storing session data. Particularly, an application server will store session data in local memory, but will also write a copy of the session data to the session database. If a different server services a request from a client, that different server can go to the database and read out the session data for the corresponding session.

Session data may include any attribute (individual piece of data) that the Web site operator feels is useful to maintain. Generally, session attributes can be considered to be of one of two types, namely, administrative attributes and application attributes. Application attributes comprise data used by an application program operating in conjunction with the HTML, such as through an API. For instance, information as to what is in a client's electronic shopping cart is such application data. Administrative attributes are items used for facilitating the processing of requests and are usually transparent to the users. They include data such as the time at which a session was created, the time of the last request associated with that session and a time out interval. The time out interval is the maximum amount of time between requests that is allowed before the server system will close out the session.

The session data for a session is updated in both the local memory and the database each time a request causes a change in the data. Particularly, the server updates the http session data in its local memory and also writes that data to the database after each request. Another method that has been used is herein termed manual update. With manual update, the servlet operator can, explicitly within the servlet code, direct the servlet to write its locally stored session data to the database.

Writing to the database is a relative expensive process in terms of consumption of processing power and time. Accordingly, it is desirable to reduce the number of writes to an http session database in order to conserve system resources.

Accordingly, it is an object of the present invention to provide an improved method and apparatus for updating http session data in a database server of a server farm.

It is another object of the present invention to provide a method and apparatus for writing http session data to a database that minimizes use of system resources.

It is a further object of the present invention to reduce the number of writes to an http session database.

It is yet a further object of the present invention to provide an asynchronous, time-based, method and apparatus for updating http session data in a database.

### SUMMARY OF THE INVENTION

The invention is a method and apparatus for updating a session database that is accessible by multiple servers. In accordance with the invention, each server maintains http session data in a local memory. This copy of the http session data will be updated every time there is a change in the session data. The servers write a copy of the session data to a common database shared by all of the servers automatically at designated times. In a preferred embodiment of the invention, the designated time is periodic (eg, every 125 seconds). In alternate embodiments, the servers may write the session data to the database after a specified number of requests in that session have been received. In another embodiment, the servers may write the session data to the database after a specified number of changes to the session data have been made.

This scheme will substantially reduce the number of writes to the database, thus reducing strain on system resources.

### BRIEF DESCRIPTION OF THE DRAWINGS

FIG. 1 is a block diagram showing a network system architecture including a server system in accordance with the present invention.

FIG. 2 is a flow diagram illustrating process flow at the server in accordance with the present invention.

### DETAILED DESCRIPTION OF THE INVENTION

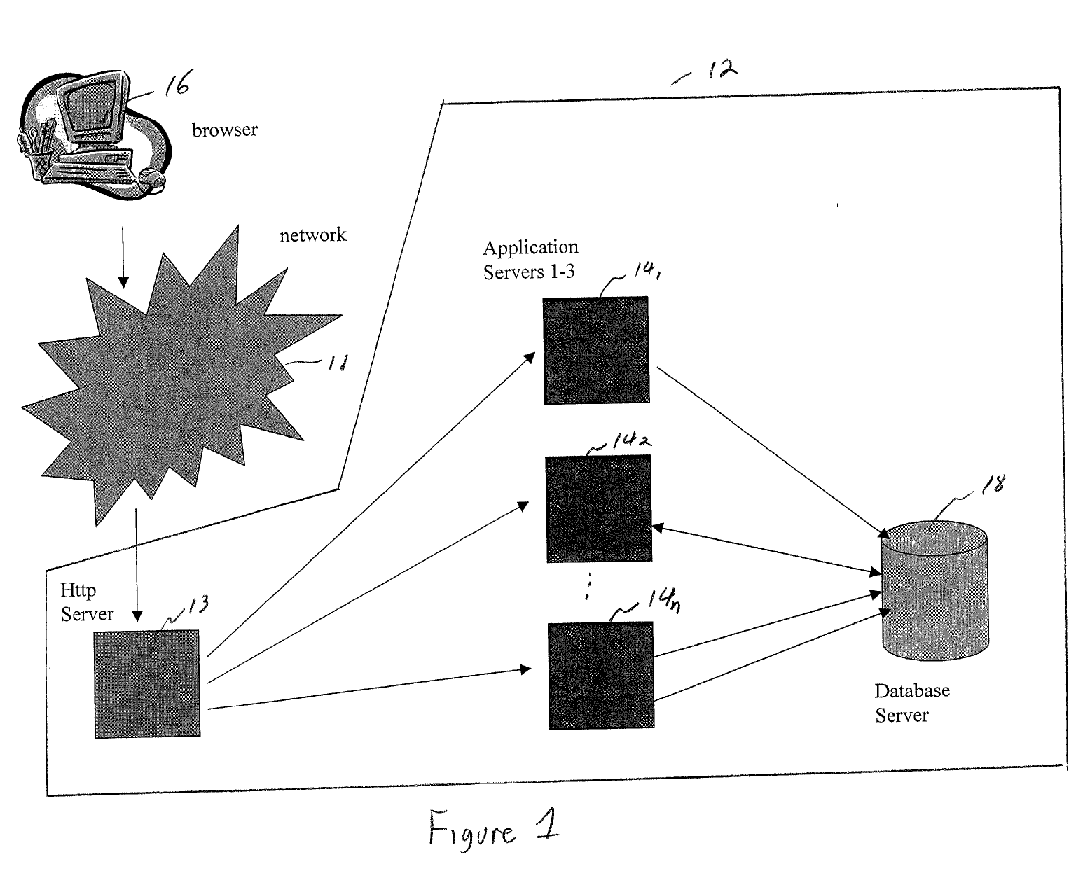

FIG. 1 is a block diagram of a communication network system architecture including a server system according to a preferred embodiment of the present invention. The invention will herein be described in connection with the Internet and http. However, it will be understood by those of skill and the art that the invention is applicable to any type of distributed communication network in which copies of session data are maintained in a shared database in any manner. Further, while the invention is particularly adapted and suitable for use in connection with session data maintained in the form of HttpSession objects of Java servlet APIs in J2EE (Java™2 Platform, Enterprise Edition) it can be applied to any manner of maintaining state data for a communication session on a distributed network. Information on J2EE can be obtained from Sun Microsystems, Inc. of Palo Alto, Calif., USA.

Referring to FIG. 1, as previously noted, the Internet 11 essentially is a distributed communication network that spans the globe. A Web site operator operating a server system 12 couples to the Internet 11 through one or more http servers 13. The http server is coupled to one or more application servers 14₁, 14₂, . . . , 14ₙ. Each application server 14₁-14ₙ is essentially redundant of the other application servers and is capable of serving the same content and performing the same processing tasks. In addition, the server system may include a database server 18 for storing content accessible to the application servers that may be necessary for processing the http requests.

For instance, in connection with a retail Web site that sells goods via the Internet, the http server(s) 13 handle all tasks relating to interfacing to the clients via the Internet using http, ftp, etc. The application server(s) 14 handle application processing tasks such as creating a purchase order, creating an invoice, checking stock to determine if a requested product is available, creating a shipping order, calculating tax and shipping charges, adding such charges to the price of the item being purchased, checking the validity of a credit card number used to charge for the purchase, etc. The application server(s) 14 access necessary data for performing these tasks, such as inventory data, shipping data, etc. from the database server(s) 18. The http server(s) 13 interface with the application server(s) 14 using tools such as Java servlet APIs.

In the case of a Web site that dynamically creates Web pages responsive to requests (rather than simply storing pages), the application server(s) would also perform the tasks of dynamically creating the Web pages using data stored in databases maintained in the database server(s).

An individual wishing to view Web pages via the Internet runs Web browser software on his or her computer or client machine 16. Web browsers are capable of communicating using http, ftp and other protocols. A client Web browser can issue http requests via the Internet to any particular server system for content to be presented to it in the form in HTML pages. When a server system 13 receives such a request, it returns the requested HTML page to the requesting client and creates http session data for the session. Although there are other options, in one option, Web site operators who wish to maintain session information operate Java-enabled application servers capable of running Java servlet API's, and utilize the HttpSession object to maintain the session data.

As previously mentioned, when there are multiple, redundant, application servers 14, it is possible, if not likely, that requests in a single http session may be serviced by different application servers. Accordingly, the various servers must be able to obtain the session data (e.g., the HttpSession object) for a given session that may have had previous requests serviced by a different one of the application servers. Accordingly, one of the databases maintained in the database server 18 is a session database. Data for http session handled by any of the server, 14₁-14ₙ, is stored in the session database. Thus, when an application server handles an http request in connection with a particular session for which that server does not have a local copy of the corresponding session data (for example, because it has not serviced any of the previous requests pertaining to that session), it can go to the session database to read out the session data that was written to the database by the server that processed the previous requests in that session.

Accordingly, each server maintains a copy of the session data for each of the http sessions that it is servicing in a local memory and also writes a copy of the session data to the http session database 18. If a server switch occurs for a given session, the new server can go to the database and request the session data pertaining to that session.

The present invention is a method and apparatus for writing session data to the database in a manner which minimizes the number of writes to the session database.

In accordance with the HttpSession object of J2EE, a Web developer can assign a session attribute for essentially any state information desired. Some types of data attributes, especially administrative data like the aforementioned “session create time” and “time out interval” are examples of administrative data that would not normally change once a session is created. (However, some Web site operators do dynamically change the time out interval as sessions progress). The “last access time” attribute, on the other hand, is a session attribute that would change every time a request is received. Other session attributes, particularly application attributes, may change only occasionally during a session.

In accordance with the invention, instead of updating the session data in the database after every request or every attribute change, each of the servers maintains a fully current copy of the http session data in its local RAM, but writes a copy of the session data to the central database only at specified intervals. The interval may be fixed or can be configurable by a Web site operator. The appropriate write interval will depend on the particular situation and would likely depend on such criteria as the nature of the content served by the Web site, the number of redundant application servers that could service different client requests in a given session, the load balancing scheme among the various redundant servers used in the web site, the nature of the session data that is maintained, the amount of traffic, the connection speed, and other factors. Write intervals in the range of 10 seconds to 5 minutes should be adequate in most cases. Further, the write interval need not be the same for all servers or even all JVMs running on a particular server. Even further, the write interval may be dynamically changed responsive to network or Web site conditions. The write interval may even be dependent upon the type of content being served in any given session or even the particular client. For instance, the Web site operator may dynamically collect data to determine the surfing characteristics of persons who visit its site and set the write interval based partially or wholly on those characteristics.

In at least one preferred embodiment, the writes to the database are controlled in a distinct processing thread. Particularly, in one embodiment a timer may be maintained for every active session, the timer being reset after every write to the database for that session. When the timer pops (i.e., the predetermined desired interval between writes expires), the corresponding session data is written out to the database and the timer is reset again.

Alternately, the writes of session data to the central database are performed responsive to the next request after the expiration of the predetermined interval (i.e., at the end of the service method invocation of the next request after expiration of the interval).

In accordance with the session database updating scheme of the present invention, it is possible for the database to contain a version of the http session data that is not fully current. This is a sacrifice that many Web site operators may be willing to accept in view of the substantial benefits in decreased database traffic achieved in accordance with the present invention. However, in a preferred embodiment of the invention, the load balancing scheme for the server system is configured such that http requests in a particular session are always sent to the same application server unless that server goes down. With such a load balancing configuration, reads from the session database would occur rarely, and particularly, only in server failure type situations.

Java servlet API version 2.2 introduced changes to Java servlets that better enable implementation of the current invention. Particularly, in version 2.2, Java servlets now limit the scope of an http session to a single Web application and explicitly prohibit concurrent access to session data from separate JVMs, but allows for concurrent access within a single JVM. Accordingly, reads from a central session database in accordance with the present invention should be infrequent and, generally, should occur only in server failure type situations.

The following details are implemented in a preferred embodiment of the invention. A write to the session database should be performed at the end of the predetermined interval only if the session has been modified since the last write to the session database. If the predetermined write interval has expired and the session has only been retrieved (i.e., request. get session ( ) was called) since the last write, then the last access time should be written to the database. If the predetermined write interval for a session has expired and the session properties have been modified since the last write to the session database, then the session attributes should be written to the database as well as the last access time. It will be understood by persons of skill in these arts that the modifications to the session attributes may have occurred over multiple http requests.

If the time between servlet requests for a particular session is greater than the predetermined interval, then the session data effectively gets written to the session database every time it is modified.

The memory for storing the session data locally to the server should be large enough to hold all of the active session data. Failure to provide a large enough memory will result in extra writes to the session database since the creation of a new session request may result in the need to write out the oldest locally stored http session to the database.

Further, as previously alluded to, most Web developers provide a time out interval that is a predetermined amount of time that will be allowed since the last request for a session before the session will be closed, i.e. the session data will be invalidated. The time out interval must be large enough to ensure that a session is not inadvertently invalidated prior to the http session data being written to the session database.

In one embodiment of the invention, the http session data is always written to the http session database immediately at the end of the initial service method (i.e., upon the initial creation of an http session). Thereafter, writes to the session database will be performed in accordance with the predetermined intervals as described above. Alternately, the initial write to the session database can be deferred.

In other embodiments of the invention, the designated times for writes to the session database may not be simply interval based, but may depend on other or additional criteria. Such criteria may include (1) the number of requests in a session since the last write to the database, (2) the number of changes made to the locally stored session data in a session since the last write to the database, or (3) some combination of any of the above-noted factors and/or a specified interval. For instance, the designated time for writing session data to the database may be (1) 125 second after the last write to the database, but only if the local copy has been updated since the last write to the database for that session or (2) after 3 updates to the local copy of the session data, whichever occurs first.

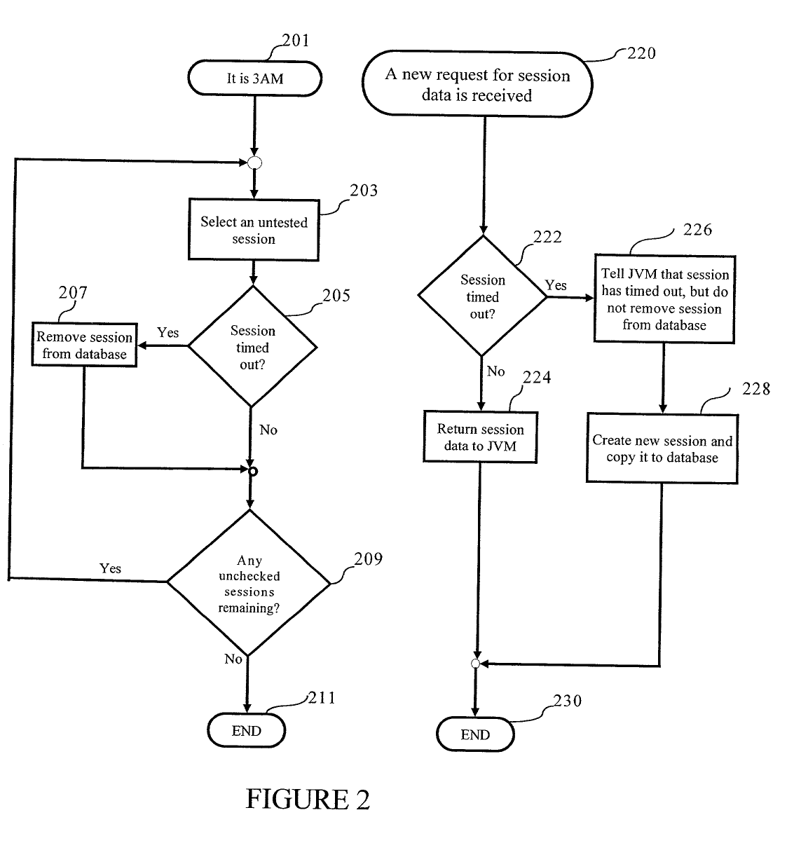

FIG. 2 is a simplified flow diagram illustrating processing at the application server for generating and maintaining http session data locally to the server and writing the http session data to the session database. In the embodiment illustrated in FIG. 2, the writing to the session database is performed in a separate processing thread as previously mentioned. Also, in this embodiment, the session data is maintained using the HttpSession object of Java servlet version 2.2, as previously discussed. In step 201, the server is asked by the http server to process an initial http request for a Web page that commences a session. In step 203, at the end of the service method for the initial request, the server creates an HttpSession object under Java servlet version 2.2. In step 205, the HttpSession object is stored in local RAM. In the particular embodiment of the invention illustrated in FIG. 2, the session data is immediately written to the session database at the end of the initial service method, as shown in step 207. Alternately, the writing of the initial session data to the session database may be deferred just as all other writes to the database will be deferred in accordance with the invention.

In step 209, the server receives the next http request pertaining to the session. At the end of the servlet service method corresponding to that request, the HttpSession object stored in local RAM is updated, if necessary, as shown in step 211. However, the updated HttpSession object is not written to the http session database at this time.

In step 213, the server checks if the session has ended, such as by timing out or being expressly closed by the application server. If not, no action is taken and the server waits for the next request. If the session has timed out, flow proceeds to step 215 where the session is closed. Closing the session may involve marking the HttpSession object data invalid in local memory at the server. It may also involve instructing the database to delete the copy of the http session data for that particular session in the database. However, it should be understood that it is not necessarily required that the http session data in either the database or in the local memory be deleted immediately. The process ends at step 217.

A separate processing thread to scan and update the session database is invoked when a timer reaches a predetermined time, e.g., 10 seconds, since the last scan for sessions in the database that need updating. At that time, the timer is reset, as shown in step 232. Then, in step 234, an unchecked HttpSession object stored locally at a server is selected. In step 236, that session is polled to determine if it has been more than 125 seconds since the last time it was written to the database. This may be accomplished by comparing a “last write time” attribute of the Httpsession object to the current time. The “last write time” attribute indicates the last time this Httpsession object was written to the database. If it has not been more than 125 seconds, the process skips to step 240 to determine if there are any more sessions that need to be checked. If it has been more than 125 seconds since the last write to the database for this session, flow proceeds to step 237. In step 237, it is determined if the locally stored copy of the Httpsession object has been updated within the last time it was written to the database. This may be accomplished, for instance, by interrogating the “last access time” attribute of the HttpSession object and comparing it to the current time. The “last access time” attribute indicates the last time that the locally stored copy of the object was modified. If it has not been modified since the last write to the database for this session, then there is no need to rewrite the object in the database (since it has not changed) and flow proceeds directly to step 240. If the locally stored copy of the object has been updated since the last write to the database, then flow proceeds to step 238, where the object is written to the session database.

In step 240, it is determined if there are any unchecked HttpSession objects remaining in the database. If so, flow returns to step 234 to check the next object and the process continues to flow through steps 234-240 until all objects have been checked and updated as necessary. When all HttpSession objects have been checked, the processing thread ends as shown at step 242. The thread will be invoked subsequently when the timer reaches 10 seconds again.

It should be understood by those of skill and the art that the flow chart of FIG. 2 is a simplified flow chart and, particularly, that it shows only steps pertinent to the present invention. Of course, there are many more steps involved with respect to each http request in a session.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

I claim:

1. A server system utilizing an HttpSession object in a Java servlet application program interface (API) comprising:
a plurality of Java Virtual Machines (JVMs) running on at least one server, said at least one server including a local memory;
a second memory having a database for storing HttpSession objects for http sessions being handled by said JVMs, said memory being accessible by each of said JVMs;
a first computer program adapted to store in a memory local to said server running said JVM HttpSession data for each http session handled by said JVM;
a second computer program adapted to write to said database a copy of said HttpSession data for each said http session at a designated time that is a function of a predetermined time interval since a last write to said database of HttpSession object data for said http session.

2. The server system of claim 1 further comprising a third computer program adapted to write to said database a copy of said HttpSession object data for each said http session at the time the http session is initiated.

3. The server system of claim 2 wherein said plurality of JVMs are running on a plurality of servers.

4. The server system of claim 3 wherein said writes to said database are performed at the end of a corresponding servlet service method.

5. The server system of claim 4 wherein said server system services the World Wide Web.

6. The server system of claim 5 wherein said Java servlet APIs are J2EE servlet APIs.

7. The server system of claim 1 wherein said second program polls said session objects stored in said memories local to said JVMs to determine if said predetermined time interval has passed since they have been updated and wherein said second program is adapted to write to said database only copies of said HttpSession objects that have been updated within said predetermined time interval.

8. The server system of claim 7 wherein said second computer program is invoked at predetermined intervals.

9. The server system of claim 1 wherein said time interval is configurable.

10. The server system of claim 9 wherein said time interval is between ten seconds and five minutes.

11. A method of maintaining session data in a server system servicing a network, said server system maintaining state data pertaining to sessions, said method comprising the steps of:
(1) storing data for each session in a memory local to a server servicing said session;
(2) writing a copy of said data for each said session stored in said local memory into a central memory accessible to all servers of said server system at designated times, said designated times being a function of a predetermined time interval since a last write to said database of data for said sessions.

12. The method of claim 11 further comprising the step of:
(3) writing in said database a copy of said session data for each said http session at the time the http session is initiated.

13. The method of claim 11 wherein said server system services the World Wide Web.

14. The method of claim 11 wherein said server system comprises a plurality of Java Virtual Machines (JVMs) running on a plurality of servers, and wherein said data for said sessions comprises an HttpSession object of a Java servlet application program interface (API).

15. The method of claim 14 wherein said Java servlet APIs are J2EE servlet APIs.

16. The method of claim 11 wherein said time interval is configurable.

17. The method of claim 11 further comprising the step of:
(4) polling said session objects stored in said memories local to said JVMs to determine if they have been updated since the last time step (2) was performed; and
wherein, in step (2), only copies of said HttpSession objects that have been updated within said predetermined time interval are written to said database.

18. A server system utilizing HttpSession objects in a Java servlet application program interface (API) comprising:
a plurality of Java Virtual Machines (JVMs) running on at least one server, said at least one server including a local memory;
a memory having a database for storing HttpSession objects for http sessions being handled by said plurality of JVMs, said memory being accessible by each of said JVMs;
a first computer program adapted to store in a memory local to said server running said JVM HttpSession object data for each http session handled by a JVM;
a second computer program adapted to write a copy of said HttpSession data for each said http session in said database at designated times, said designated times determined as a function of at least one of (a) the number of times the HttpSession object data is updated in said local memory and (b) the number of times an http request in said http session is serviced.

19. The server system of claim 18 wherein said second computer program is adapted to write said HttpSession object data to said database after X HttpSession updates in said local memory, where X is an integer greater than or equal to 2.

20. The server system of claim 18 wherein said second computer program is adapted to write said HttpSession object data to said database after X http requests in said http sessions, where X is an integer greater than or equal to 2.

21. The server system of claim 17 further comprising a third computer program adapted to store in said database a copy of said HttpSession object data for each said http session at the time the http session is created.

22. The server system of claim 21 wherein said plurality of JVMs are running on a plurality of servers.

23. The server system of claim 22 wherein said Java servlet APIs are J2EE servlet APIs.

24. The server system of claim 18 wherein said writes to said database are performed at the end of a first servlet service method of a corresponding http session received after said designated time.
